(19) United States
(12) Patent Application Publication
(10) Pub. No.: US 2019/0102740 A1
(43) Pub. Date: Apr. 4, 2019

(54) SERVICE PORTAL FOR CONNECTING INVENTORS AND ENTREPRENUERS WITH THE INVESTMENT COMMUNITY

(71) Applicant: Anoushka Narayan, Austin, TX (US)

(72) Inventor: Anoushka Narayan, Austin, TX (US)

(21) Appl. No.: 15/721,347

(22) Filed: Sep. 29, 2017

(51) Int. Cl. G06Q 10/10; G06Q 50/00; G06F 21/31

(52) U.S. Cl. CPC G06Q 10/101; G06F 21/31; G06Q 50/01

(57) ABSTRACT

An innovation based economy dictates ease of mutual access between Entrepreneurs and Venture Capitalists (VCs). Ease of access to Venture capital is an existential necessity for entrepreneurs to realize the innovations they envisage in their collective minds. Any field that thrives on improving human society through new discoveries and inventions relies on a steady stream of capital for initial nourishment. Similarly, a global exposure to ideas and inventions is vital for VCs to invest wisely. This portal is envisaged to be a global clearing house for such entrepreneurs seeking seed capital for their ideas/inventions and for Venture Capitalists (VCs) seeking new ideas and horizons to invest in. The value proposition for this service portal is to mitigate the following two fundamental limitations of the VC ecosystem.
1. Entrepreneurs are forced to be in geographical proximity with Venture Capitalists to have a high probability of getting funded.
2. Venture Capitalists are limited in exposure when they have to rely on word-of-mouth or on in person pitches of ideas.

### TECHNICAL FIELD OF THE INVENTION

The present invention relates to the application of cloud based services to the Venture Capital Ecosystem. The invention relates to development of a facility to globally connect the Entrepreneur and Investor communities.

### BACKGROUND OF THE INVENTION

Venture Capital (VC) and Venture Capitalists (VCs) are the life blood of a system that helps entrepreneurs bring to existence innovations they envisage in their collective minds. Any field that thrives on improving human society through new discoveries and inventions relies on a steady stream of capital for initial nourishment. This portal is envisaged to be a global clearing house for such entrepreneurs seeking seed capital for their inventions and ideas and for Venture Capitalists (VCs) seeking new inventions and horizons to invest. There is an obvious and primal need for this kind of service. This service portal attempts to mitigate the following two fundamental limitations of the VC ecosystem:
Entrepreneurs are forced to be in geographical proximity with Venture Capitalists to have a high probability of getting funded.
Venture Capitalists are limited in exposure when they must rely on word-of-mouth or on in person pitches of ideas.
   The invention attempts to fully eliminate geographical and linguistic barriers faced by entrepreneurs in their bid to generate interest within the investment communities (VCs). In this attempt, the online service portal provides a cloud based, secure venue to all registered entrepreneurs, irrespective of their geographical locations to pitch their innovations to a global collective of Venture Capitalists (VCs). The portal also envisages providing translation services, either in real time or as an additional add-on.

The claim of invention here is for a process (and facility) where in the service eliminates geographical barriers that routinely haunt entrepreneurs. The invention also claims to provide a global exposure of innovations to VCs unrestricted by geographical and language barriers. The main intent and scope of this portal is limited to initially connect the two interested entities. There is an obvious and primal need for this kind of service.

### SUMMARY OF THE INVENTION

This service is envisioned as a global exchange center for Venture Capitalists on one side and Entrepreneurs on the other. Two independent and secure types of accesses are designed, one for the Entrepreneurs and a second for the Venture Capitalists (VCs).
1. Entrepreneurs are provided a forum to publish and present their ideas (intellectual property) for perusal by interested VCs. This intellectual content is strictly owned and controlled by the Entrepreneurs themselves with exclusive modification rights. The intellectual content is packaged into a portfolio, vetted and flagged by the Entrepreneurs themselves for review by VCs. Only the Entrepreneurs themselves can view their intellectual content until the time they grant read access to the VCs. The invention also covers any technical translation facilities to be provided on the fly to facilitate multi-geography exposure.
2. All investors (VCs) are vetted for their credentials and determined to have a legitimate interest in seed fund investing. The VCs are then provided with access to preview all the abstracts of the intellectual content generated by the Entrepreneurs as individual portfolios. Each such portfolio is tracked against a list of registered VCs. If VCs are interested in specific portfolios, they can correspond with the Entrepreneur of the specific portfolio on a one-to-one basis.
3. Once the VC gets in touch with the Entrepreneur, the Entrepreneur is free to grant full access to the VC which can be revoked at the discretion of the Entrepreneur. The full access here means the complete description of the invention and/or vision of the Entrepreneur. This action of granting access allows the VC to see information that could otherwise be infringed upon had it been open to the public.

### BRIEF DESCRIPTION OF THE FIGURES

FIG. 1 is a flow-chart for the Entrepreneur access to the service portal

FIG. 2 is the flow-chart for the Investor access to the service portal

FIG. 3 is the flow-chart for processing multiple Investor interest in a single invention/idea.

### DETAILED DESCRIPTION OF THE INVENTION

The present invention provides a method and description of a system for connecting inventor/entrepreneur and investor/VC communities on a global scale. Towards this end, we describe one embodiment of such a system by defining a common cloud based portal that provides targeted services to both the communities. This embodiment of the portal is a secure database with separate graphical user interfaces to each of the communities.

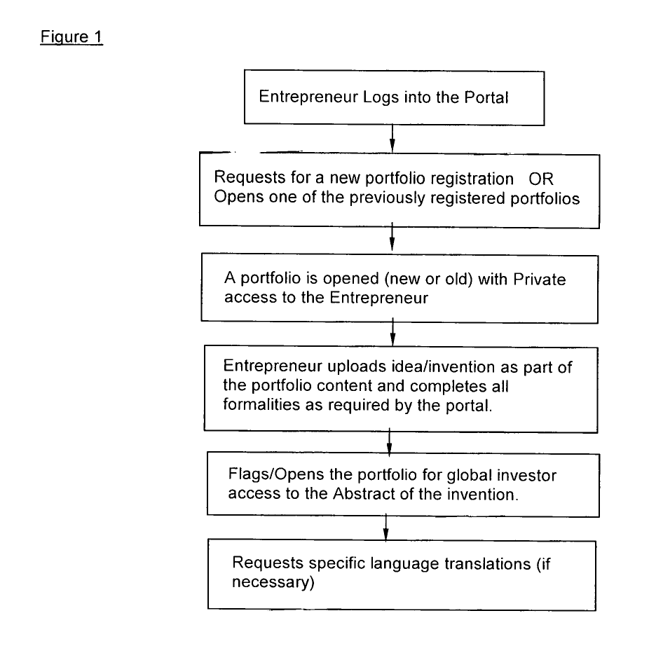

The inventors/entrepreneurs register themselves with the portal and are provided with secure authentication as an entrepreneur client. The portal provides a client interface to the entrepreneur to describe and/or upload their inventions and ideas in detail. The inventors publish the content of their inventions through this interface. The inventors also provide an abstract intended for perusal by the investment community. The portal natively provides a list of branches or domains under which the said invention can be listed. The inventors provide guidance and specify the domain under which the uploaded content needs to be listed. Additionally, if warranted, an inventor can also request the portal for a new branch/domain to be listed and translation services to other languages. The published/uploaded content is secured and under complete access control of the originators of the said inventions. FIG. 1 captures, in summary, the client interface and actions specific to the entrepreneur.

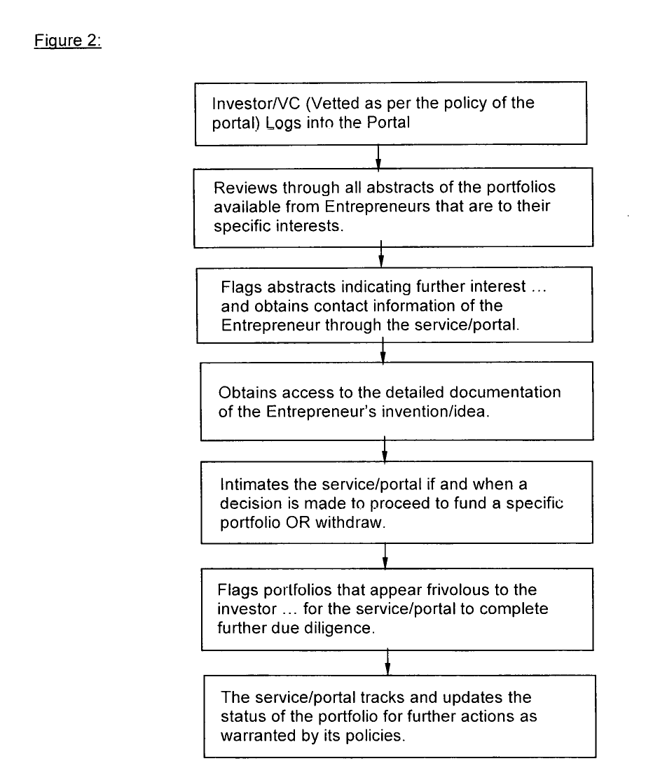

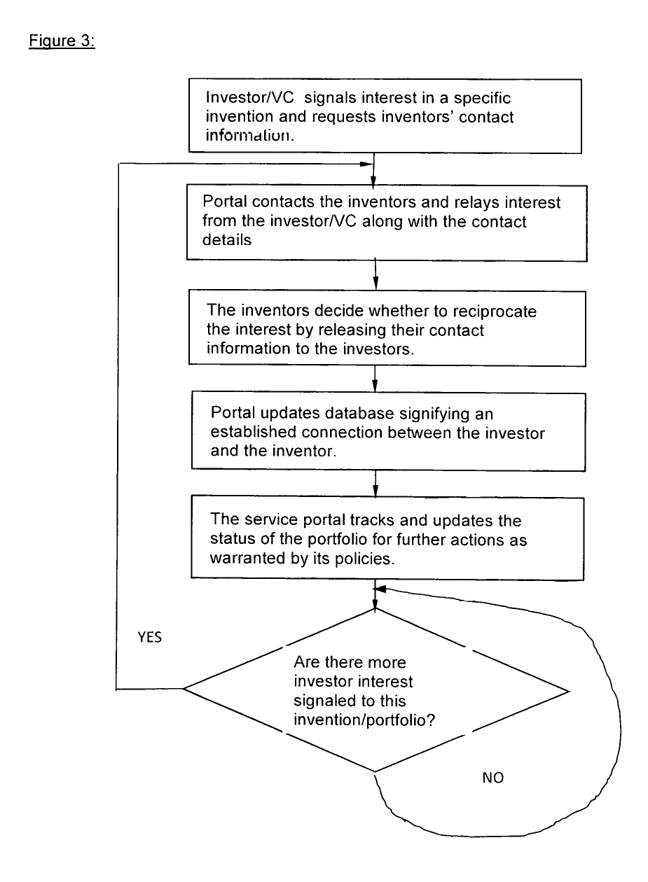

The investors/VCs register themselves with the service portal and are vetted by the portal for authentication. The portal maintains a live list of investors in good standing within its scope. The portal provides a client interface to the investor in the form of a browser. At the outset, the investors have access to the abstracts of all the published/uploaded content that have been granted access by the inventors/entrepreneurs. They however do not have access to the detailed content FIG. 2 captures, in summary, the client interface and actions specific to the investor/VC. This method does not attempt to vouch for or verify the authenticity and validity of the inventions listed on its portal. However, the method provides for addressing validity concerns from the investment community. In a second step, interested investors will request the service portal for the contact information of the inventors. This portal relays this interest to the concerned inventor/entrepreneur. Only on confirmation, by the service portal, of existence of mutual interest between an inventor and an investor, will the contact information be provided to either side. Investors can only get access to the details of the invention under the explicit permission of the inventors after the initial exchange of the contact information. The flow chart for inventor/investor interaction is described in FIG. 3.

Although the present invention has been described in terms of a single embodiment, it is not intended that the invention be limited to this one. Modifications within the spirit of the invention will be apparent to those skilled in the art. For example, both the client interface for the inventor and the browser interface for the investor can take myriad of different forms. Also, obvious alternate modifications to handle situations when multiple investors to a single invention/idea are examples of extensions to this basic method.

We claim:

1. A cloud based method that provides a portal to entrepreneurs for publishing their invention and ideas on the internet to the investor community.

2. A cloud based method that provides credentialed investors with access to the inventions and ideas from claim 1 for investment opportunities.

3. A cloud based method that facilitates entrepreneurs in claim 1 overcome the language barriers and enhance access to investment opportunities.

4. A cloud based method that provides investors in claim 2 a global access to inventions and ideas without language barriers.

5. The method of claim 1 wherein the access to the inventions and ideas published by the entrepreneur are secure and is under direct control of the entrepreneur.

6. The method of claim 2 wherein the said investor is vetted and credentialed to maintain the security of entrepreneurial content from claim 1 within the portal.

7. The client system interface for claims 1 and 3 wherein the display component is form based.

8. The client system interface for claims 2 and 4 wherein the display component is a browser.

9. The server system for claims 1 through 5 is a database that accommodates all the components in the said claims.

10. The method of claim 2 wherein a user of the portal will need to explicitly identify themselves when utilizing the services of the portal.

11. The method of claim 2 wherein a user of the portal is only allowed a limited exposure of the entrepreneurial content controlled by and at the exclusive discretion of the entrepreneur owner.

12. The method of claim 2 wherein multiple users(investors) interested in a single invention/idea are handled as per the interests of the entrepreneurs.
